(19) United States
(12) Patent Application Publication
(10) Pub. No.: US 2008/0175346 A1
(43) Pub. Date: Jul. 24, 2008

(54) Energy Reactor Containment System

(76) Inventor: John S. Lamont, Winnipeg (CA)

Correspondence Address: ADE & COMPANY INC., 2157 Henderson Highway, WINNIPEG, MB, R2G1P9, omitted

(21) Appl. No.: 12/034,349

(22) Filed: Feb. 20, 2008

Related U.S. Application Data
(63) Continuation-in-part of application No. 11/217,605, filed on Sep. 2, 2005, now abandoned.

(30) Foreign Application Priority Data
Apr. 12, 2005 (CA) 2505105

(51) Int. Cl. G21C 19/303

(52) U.S. Cl. 376/361

(57) ABSTRACT

An energy reactor containment system comprises an outer containment chamber and an inner containment chamber supported within the outer containment chamber to define a space between respective walls of the inner and outer containment chambers. Water is contained within the space for generating steam which feeds turbine generators. Fuel for an energy reaction is suspended within the centre of the inner containment chamber by a suitable mechanism. The structure permits the water or another incompressible fluid to be used both for producing usable steam and for absorbing blast impact due.

This application is a continuation-in-part of U.S. patent application Ser. No. 11/217,605, filed Sep. 2, 2005.

### FIELD OF THE INVENTION

The present invention relates to a containment system for capturing energy from an energy reactor.

### BACKGROUND

Two diverse technical approaches to fusion power are generally known, magnetic confinement fusion, also known as magnetic fusion energy (MFE) and inertial confinement fusion, also known as inertial fusion energy (IFE). These form the basis of a large number of fusion research programs. Magnetic confinement techniques, studied since the 1950s, are based on the principle that charged particles such as electrons and ions, ie, deuterons and tritons, tend to be bound to magnetic lines of force. Thus the essence of the magnetic confinement approach is to trap a hot plasma in a suitably chosen magnetic field configuration for a long enough time to achieve a net energy release, which typically requires an energy confinement time of about one second. In the alternative IFE approach, fusion conditions are achieved by heating and compressing small amounts of fuel ions, contained in capsules, to the ignition condition by means of tightly focused energetic beams of charged particles or photons. In this case the confinement time can be much shorter, typically less than a millionth of a second.

Because the maximum plasma density that can be confined is determined by the field strength of available magnets, MFE plasmas at reactor conditions are very diffuse. Typical plasma densities are on the order of one hundred-thousandth that of air at STP. The Lawson criterion is met by confining the plasma energy for periods of about one second. A totally different approach to controlled fusion attempts to create a much denser reacting plasma which, therefore, needs to be confined for a correspondingly shorter time. This is the basis of inertial fusion energy (IFE).

In the IFE approach, small capsules or pellets containing fusion fuel are compressed to extremely high densities by intense, focused beams of photons or energetic charged particles. Because of the substantially higher densities involved, the confinement times for IFE can be much shorter. In fact, no external means are required to effect the confinement; the inertia of the fuel mass is sufficient for net energy release to occur before the fuel flies apart. Typical burn times and fuel densities are 10⁻¹⁰ s and 10³¹-10³² ions/m³, respectively. These densities correspond to a few hundred to a few thousand times that of ordinary condensed solids. IFE fusion produces the equivalent of small thermonuclear explosions in the target chamber. An IFE power plant design, therefore, must deal with very different physics and technology issues than an MFE power plant, although some requirements, such as tritium breeding, are common to both. Some of the challenges facing IFE power plants include the highly pulsed nature of the burn, the high rate at which the targets must be made and transported to the beam focus, and the interface between the driver beams and the reactor chamber.

In inertial fusion the fuel is compressed and heated using driver beams. Achieving ignition requires a large amount of energy to be precisely controlled and delivered to the fuel target in a very short time, and the target must be capable of absorbing this energy efficiently. To produce net energy, the IFE system must have gain, ie, more energy output than was used to make, compress, and heat the fuel. Driver efficiency and capsule design and fabrication are therefore important issues for an IFE reactor.

The necessary energy can be delivered to the fuel by a variety of possible drivers. The four types of drivers receiving the most research attention are solid state lasers, KrF lasers, light-ion accelerators, and heavy ion accelerators. The leading driver for target physics experiments worldwide is the solid-state laser, and in particular the Nd:glass laser. The reason is that the irradiances required for IFE are in the 10¹⁸-10¹⁹ W/m² range. The Nd:glass laser was the first driver which could produce these large power densities on target and it has remained in the forefront because of its high performance, reliable technology, and relative ease of maintenance. Low efficiencies and pulse rates have traditionally eliminated Nd:glass lasers from serious consideration in IFE reactor designs. However, new Nd:glass technology, replacing flash lamp pumping with higher efficiency diode pumping and utilizing crystalline disks and gas cooling, could change this view. Higher driver efficiencies are achievable in KrF lasers and particle beam accelerators. Particle beams have thus far had difficulty in achieving the low divergences and small focal spots required for IFE experiments, a technical area where lasers have a natural advantage. In IFE reactors, however, focal spots as large as 1 cm are permitted, and it appears that both light and heavy ion drivers could meet this requirement.

Two types of IFE targets have been investigated known as direct and indirect drive targets. Direct-drive targets absorb the energy of the driver directly into the fuel capsule, whereas indirect-drive targets use a cavity, called a hohlraum, to convert the driver energy to x-rays which are then absorbed by the fuel capsule. This latter method can tolerate greater inhomogeneities in driver illumination, albeit at the expense of the efficient delivery of energy to the capsule.

The extremely high peak power densities available in particle beams and lasers can heat the small amounts of matter in the fuel capsules to the temperatures required for fusion. In order to attain such temperatures, however, the mass of the fuel capsules must be kept quite low. As a result, the capsules are quite small. Typical dimensions are less than 1 mm. Fuel capsules in reactors could be larger (up to 1 cm) because of the increased driver energies available. (Reference: Ellis, William R., 1993, “Fusion Energy” in Encyclopaedia of Chemical Technology, Volume 12, John Wiley & Sons, Inc.)

U.S. Pat. No. 4,690,793 to Hitachi Ltd. et al, U.S. Pat. No. 4,836,972 to Bussard et al, U.S. Pat. No. 5,410,574 to Masumoto et al. and U.S. Pat. No. 6,654,433 to Boscoli disclose various examples of fusion reactions however none describe a simple means of absorbing the force and heat from a fusion reaction to produce useful steam for driving a turbine.

### SUMMARY OF THE INVENTION

According to one aspect of the present invention there is provided an energy reactor containment system comprising:

an outer wall defining an outer containment chamber therein;

an inner wall defining inner containment chamber supported within the outer containment chamber to define a space between outer wall of the outer containment chamber and the inner wall of the inner containment chamber;

a liquid filling the space between the walls of the inner and outer containment chambers;

a feed arranged to introduce the liquid into the space between the walls;

a target placer arranged to place a target fuel within the inner containment chamber;

a driver arranged to initiate an energy reaction which consumes the target fuel;

the liquid within the space between the walls of the inner and outer containment chambers being arranged to form a gas in the space between the walls of the inner containment chamber and the outer containment chamber responsive to the energy reaction; and

a collector arranged to collect the gas formed in the space directly from the space between the respective walls of the inner and outer containment chambers as the liquid in the space is heated by the energy reaction.

By providing a structure in which fluid, for example water, is received within a space between inner and outer chamber walls, the fluid acts both to absorb elevated pressure of the energy reaction due to its incompressible nature, while also producing gas for driving a turbine when absorbing heat from the energy reaction.

There may be provided a shock absorption system coupled in communication with an interior of the inner containment chamber in which the shock absorption system comprises a moveable column of fluid which is arranged to be lifted when pressure within the inner containment chamber elevates.

There may also be provided a valve in communication with the column of fluid, the valve being operable between an open position and a closed position in which the valve prevents further movement of fluid within the column in the closed position such that further relief of pressure in the inner containment chamber is prevented when the valve is closed.

There may be provided an inlet chamber defining a volume external from an interior volume defined by the inner chamber and in communication between the interior of the inner containment chamber and the column of fluid.

Preferably both the inner and outer containment chambers are spherical and concentric with one another.

An exterior of the outer containment chamber may be insulated.

An interior surface of the inner containment chamber preferably includes a liner of wear resistant material.

The inner containment chamber may be formed of a plurality of plates abutted with one another in an overlapping configuration.

Preferably each plate is supported by a respective post spanning the space between the inner and outer containment chambers.

There may be provided a plurality of channels spanning between the inner and outer chambers arranged to receive respective driver beams of the driver therethrough.

Each channel includes a cover member which is rotatable between an open position arranged to communicate the driver beams therethrough and a closed position in which the channels are covered.

The target placer preferably comprises a mechanism arranged to suspend the target fuel at a center of the inner containment chamber.

An interior of the inner containment chamber in some embodiments may be partially filled with a metal when the inner walls of the inner containment chamber are arranged to be operated at a temperature and pressure to maintain the metal in a flowable liquid form.

When provided in combination with a steam driven turbine arranged to generate electricity, the steam driven turbine is preferably arranged to communicate with the collector so as to be arranged to generate electricity by the formation of the gas in the space between the inner and outer walls.

There may be provided a plurality of heat exchanger passages supported on the inner walls of the inner containment chamber and arranged to communicate heat exchanger fluid between the inner containment chamber and an energy generating device arranged to produce useful energy from heat extracted from the heat exchanger fluid.

According to another aspect of the present invention there is provided an energy reactor containment system comprising:

an outer wall defining an outer containment chamber therein;

an inner wall defining inner containment chamber supported within the outer containment chamber to define a space between outer wall of the outer containment chamber and the inner wall of the inner containment chamber;

a liquid filling the space between the walls of the inner and outer containment chambers;

a feed arranged to introduce the liquid into the space between the walls;

a target placer arranged to place a target fuel within the inner containment chamber;

a driver arranged to initiate an energy reaction which consumes the target fuel;

the liquid within the space between the walls of the inner and outer containment chambers being arranged to form a gas responsive to the energy reaction;

a collector arranged to collect the gas formed as the liquid in the space is heated by the energy reaction;

a shock absorption system coupled in communication with an interior of the inner containment chamber, the shock absorption system comprising
a moveable column of fluid which is arranged to be lifted under force of elevating pressure within the inner containment chamber to relieve pressure in the inner containment chamber; and
a valve in communication with the column of fluid, the valve being operable between an open position and a closed position in which the valve prevents movement of fluid within the column in the closed position such that relief of pressure in the inner containment chamber is prevented when the valve is closed.

There may be provided an inlet chamber defining a volume external from an interior volume defined by the inner chamber and in communication between the interior of the inner containment chamber and the column of fluid.

In this instance, partially filling the interior of the inner containment chamber with a metal, when the inner walls of the inner containment chamber are arranged to be operated at a temperature and pressure to maintain the metal in a flowable liquid form, serves to transfer pressure of expanding gases from the energy reaction by a flow of the metal through the liquid metal submerged inlet chambers to the column of fluid of the shock absorption system.

According to another aspect of the present invention there is provided an energy reactor containment system comprising:

an outer wall defining an outer containment chamber therein;

an inner wall defining inner containment chamber supported within the outer containment chamber to define a space between outer wall of the outer containment chamber and the inner wall of the inner containment chamber;

a liquid filling the space between the walls of the inner and outer containment chambers;

a feed arranged to introduce the liquid into the space between the walls;

a target placer arranged to place a target fuel within the inner containment chamber;

a driver arranged to initiate an energy reaction which consumes the target fuel;

the liquid within the space between the walls of the inner and outer containment chambers being arranged to form a gas responsive to the energy reaction;

a collector arranged to collect the gas formed as the liquid in the space is heated by the energy reaction;

the walls of the inner containment chamber being formed of a plurality of plates abutted with one another in an overlapping configuration; and

each plate being respectively supported on the walls of the outer containment chamber by a respective post spanning the liquid filled space between walls of the inner and outer containment chambers.

When each plate comprises flanges projecting outwardly from at least two sides, the flanges are preferably overlapped by adjacent ones of the plates. The plates are preferably overlapped so as to permit relative expansion and contraction of the plates in a circumferential direction while maintaining a fluid seal therebetween to maintain a working fluid in the space between the inner and outer walls of the inner and outer containment chambers respectively.

Some embodiments of the invention will now be described in conjunction with the accompanying drawings in which:

### BRIEF DESCRIPTION OF THE DRAWINGS

FIG. 1 is a partly sectional side elevational view of the energy reactor containment system.

FIG. 2 is a schematic top plan view of the energy reactor containment system.

FIG. 3, FIG. 4 and FIG. 5 are respective top plan, rear elevational and front elevational views of one of the plates forming the walls of the inner containment chamber of the energy reactor containment system.

FIG. 6 and FIG. 7 are partly sectional elevational views of a cover member for the driver in open and closed positions respectively.

FIG. 8 is a front elevational view of the cover.

FIG. 9 is a partly sectional side elevational view of an alternative embodiment of the energy reactor containment system.

FIG. 10 is a partly sectional side elevational view of another alternative embodiment of the energy reactor containment system.

In the drawings like characters of reference indicate corresponding parts in the different figures.

### DETAILED DESCRIPTION

Referring to the accompanying figures there is illustrated an energy reactor containment system generally indicated by reference numeral 10. The system 10 is particularly suited for producing useful work from an energy reaction which releases heat, by capturing steam released when a surrounding fluid is heated.

In a preferred embodiment, the energy reaction may comprise a fusion reaction. Alternatively, any energy reaction, for example a nuclear reaction or the combustion of various types of fuels, may drive the system in which the reaction consumes a target fuel to produce sufficient heat for converting a working fluid of the system from a liquid to a gas for subsequently producing useful forms of energy, for example the generation of electricity using a steam driven turbine or the like.

The system 10 has spherical outer walls defining an outer containment chamber 12 therein having a spherical interior. The walls of the chamber are formed of a material having a high heat resistance so as to resist damage from the high heat generated by the reaction. Suitable materials for forming the walls may include various types of metal, ceramic or composite materials which also have sufficient strength to withstand the forces generated by the reaction. The walls are also insulated by insulation 100 on an outer side to contain heat in the chamber. A rigid backing, for example concrete, is provided at the exterior of the outer chamber 12 for added structural support. In a typical installation, the system is constructed below ground.

Spherical inner walls defines an inner containment chamber 14 therein which is also spherical in shape and which is positioned concentrically within the walls of the outer chamber 12. The inner chamber 14 is smaller in diameter than the outer chamber 12 to define an annular space 16 between the outer walls of the outer containment chamber and the inner walls of the inner containment chamber. The inner chamber walls are also formed of a material having a high heat resistance and sufficient strength to withstand the heat and force generated by the reaction.

The inner chamber 14 is formed of a plurality of overlapping plates 18 each supported on the outer chamber 12 by a respective post 20 spanning across the space 16 between the walls of the inner and outer chambers. Each plate 18 includes a center post mount on a rear face thereof for connection to the post 20 which mounts on the outer chamber 12. Mounting of the plate to the post 20 is accomplished using threaded fasteners to permit selective separation thereof when the plates become worn and require replacement. The overlapping plates permit some relative movement therebetween to accommodate some expansion of the inner chamber without distortion of the inner chamber walls.

Each plate has a generally rectangular front face 22 which is concave and forms a portion of the inner surface of the inner chamber 14. A top flange 24 extends along the top edge of the front face 22 and a side flange 26 spans one side of the front face 22. Each of the flanges is recessed from the front face 22 by a thickness of the plate for being overlapped by adjacent plates when the front faces 22 thereof are positioned adjacent one another. The top flange 24 is shorter than the overall plate by the width of the side flange 26 so that the flanges do not overlap one another when the front faces of adjacent plates are abutted with one another. Similarly, the side flange 26 is shorter than the plate by the height of the top flange 24. The plates are provided with a close tolerance so that simply abutting the plates in the overlapped configuration described herein is sufficient for providing a seal between the plates for containing water within the annular space 16 between the inner and outer chamber walls. The plates are overlapped so as to permit relative expansion and contraction of the plates in a circumferential direction of the chamber walls while maintaining a fluid seal therebetween to maintain a working fluid in the space between the inner and outer walls of the inner and outer containment chambers respectively.

A shock absorption system is provided in communication with the interior of the inner chamber 14 for reducing the blast impact on the plates 18. The system 30 comprises a plurality of inlet chambers 32 in open communication with the interior of the inner chamber 14 at circumferentially spaced positions about a lower portion of the inner chamber 14. The inlet chambers 32 are much larger than the space between the inner and outer chambers and accordingly each defines a volume which projects externally beyond the inner and outer chamber with the outer chamber being sealed thereabout.

A fluid conduit 34 is coupled to the inlet chamber 32 and extends upwardly therefrom for containing a column of fluid above the inlet chamber. A plug 34 is slidably mounted within the fluid conduit 33 and acts as a seal for containing liquid above the plug and preventing leakage into the inlet chambers. The plug 34 urges the fluid in the conduit upward when pressure in the inlet chambers causes the plugs to rise. At its lowermost position, each plug 34 is substantially flush with or below the communication of the inlet chamber 32 with the interior of the inner chamber 14. A choke valve 36 is coupled to the fluid conduit 34 at a position spaced above the inlet chamber. The choke valve 36 comprises a flap valve which is rotated by a respective actuator 38 between open and closed positions. When closed the choke valve 36 seals the conduit spaced above the plug 34 to prevent further pressure relief of the plug moving upwardly to instead build gas pressure within the interior of the inner chamber 14 and the inlet chambers 32.

In use, the space 16 between the walls of the inner and outer chambers is filled with a working fluid, for example water, received through a feed inlet 40 coupled through the outer chamber walls adjacent the bottom end of the system 10. A feed valve 42 is coupled in series with the feed inlet 40 to seal off the supply of fluid into the space 16 and prevent the back pressure from escaping through the bottom of the system.

A collector in the form of a plurality of steam outlets 44 are coupled through the outer chamber walls in communication with the space 16 at circumferentially spaced positions about the top end of the system. The steam outlets 44 are joined with one another at a common outlet 46 spaced above the inner and outer chambers for collecting any steam produced directly in the space 16 by the heating of the fluid within the space 16. The common outlet 46 feeds to an electricity generating, steam driven turbine. Accordingly, the steam driven turbine is arranged to communicate with the collector so as to be arranged to generate electricity by the formation of the gas in the space between the inner and outer walls.

A target placer in the form of a fuel feeding mechanism 48 is coupled above the inner and outer chambers for depositing target fuel pellets 50 within the interior of the inner chamber 14. The feed mechanism communicates through the walls of the inner and outer chambers by a feed tube 52 extending therethrough. The mechanism 48 selectively feeds fuel pellets 50 into the sphere by suspending the pellet at the center of the sphere prior to the reaction being initiated. The feed tube is sealed closed prior to the reaction being initiated.

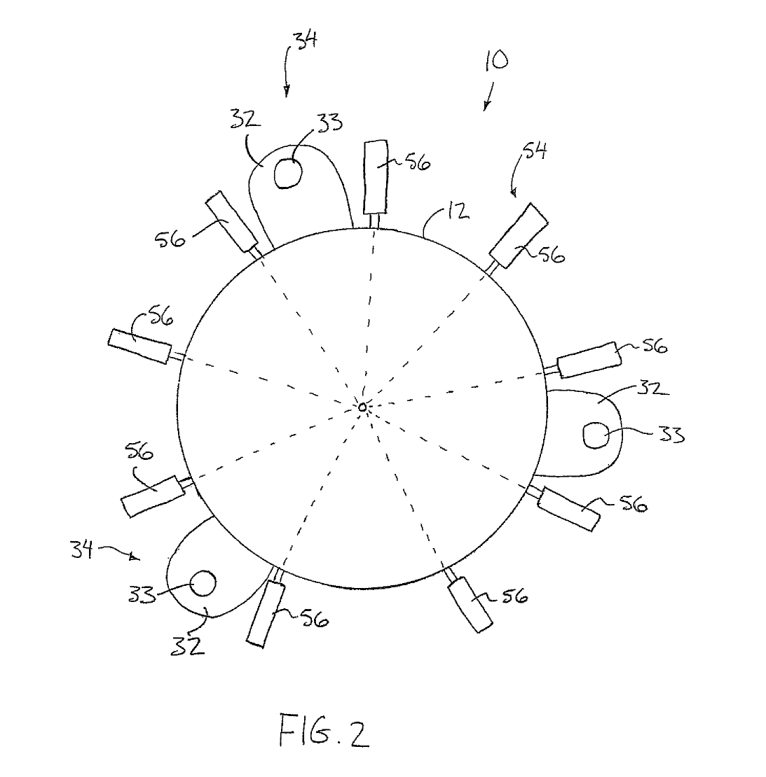

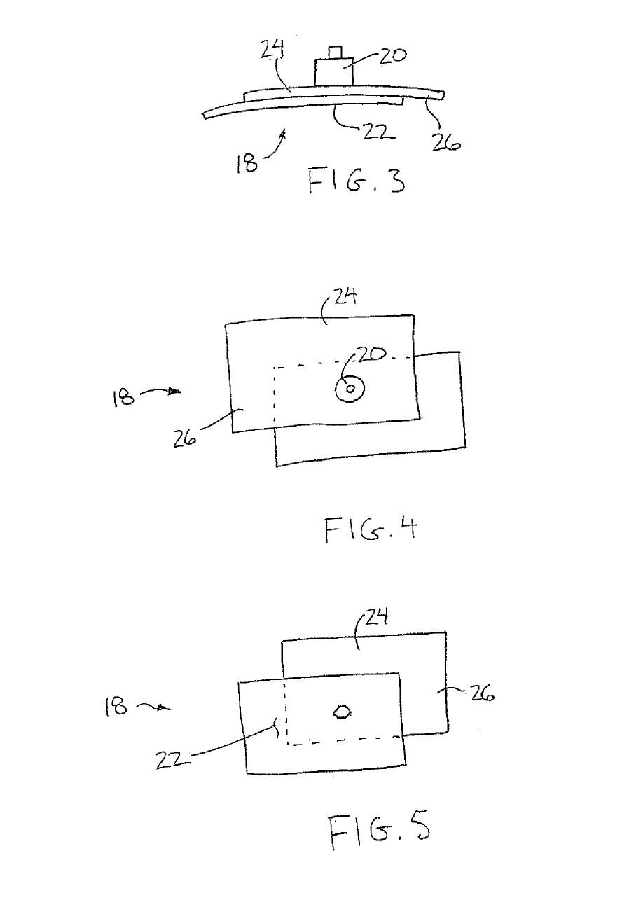

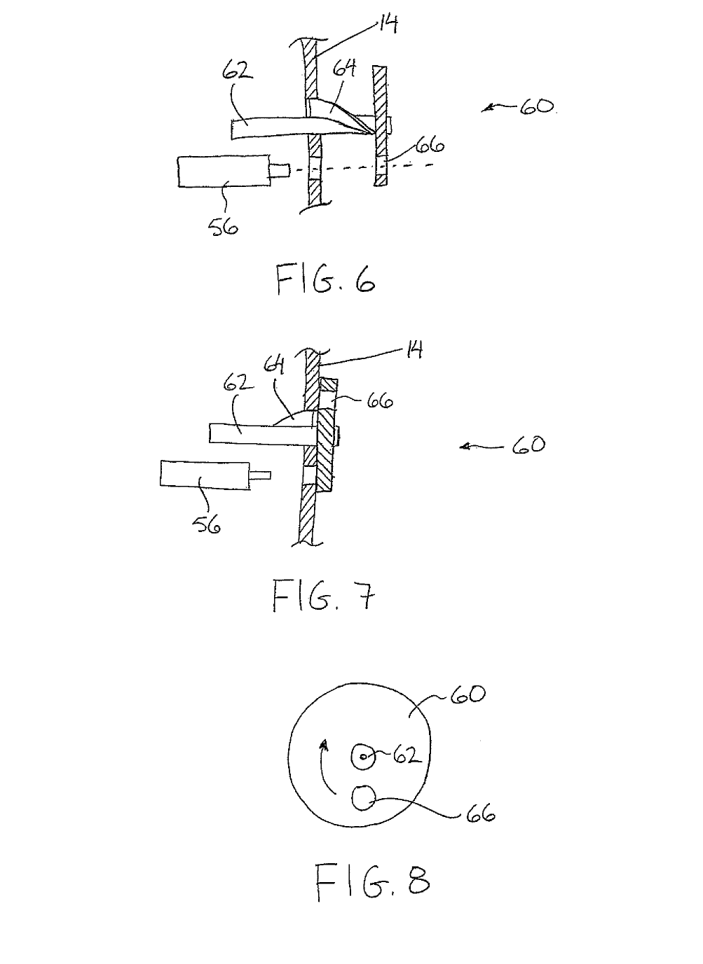

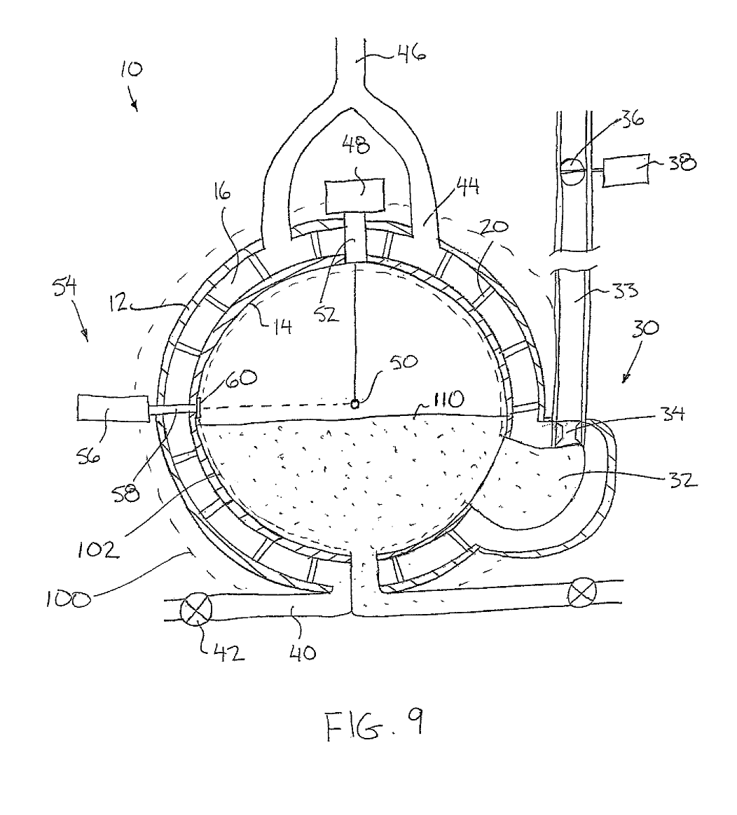

A driver mechanism 54 is provided for initiating the reaction. In a preferred embodiment in which a fusion reaction is initiated, the driver mechanism includes a plurality of lasers 56 located at circumferentially spaced positions in one or more drive planes. As shown schematically in FIG. 2 a set of nine lasers are shown in a single driver plane in which each laser is directed at a space between two opposing lasers so that none of the lasers within a single driver plane are directed at one another yet each is directed to cross a single center point within the interior of the inner chamber 14 where the target fuel pellet is suspended. Eight lasers can be provided within a single plane without being directed at one another by positioning the lasers at 40 degrees, 80 degrees, 120 degrees, 160 degrees, 200 degrees, 240 degrees, 280 degrees, 320 degrees and 360 degrees respectively. Each of the lasers communicates through the walls of the inner and outer chambers by a respective driver tube 58 sealed across the space 16 between the chamber walls. Additional lasers may be provided in different planes, but still intersecting the centre of the sphere.

Covers 60 are provided for the driver tubes 58 at the interior of the inner chambers 14 to prevent damage to the driver mechanism during the reaction. Each cover 60 comprises a circular plate supported on a respective axle 62 which is parallel and spaced beside the respective tube 58 in sufficient proximity that the cover plate 60 overlaps the opening of the tube 58. The axle 62 includes suitable flighting 64 thereabout which is engaged within a guide in the inner chamber wall such that the plate is automatically rotated about its axle 62 as the plate is displaced towards and away from the wall of the inner chamber. An aperture 66 is provided in the plate forming the cover 60 for alignment with the respective driver tube 58 when the plate is spaced inwardly from the wall of the inner chamber in an open position. When the plate is displaced towards the chamber wall, the flighting 64 causes the plate to rotate until the aperture 66 is no longer aligned with the feed tube when the plate is abutted against the wall of the inner chamber. The feed tube is thus protected when the cover 60 is in this closed position. A suitable biasing mechanism is provided to bias the covers 60 into the respective closed positions. Each cover is thus rotatable between an open position arranged to communicate the beams of the driver therethrough and a closed position in which the channels are covered and protected by the covers respectively.

In use, the plugs 34 are initially positioned at the bottoms of the respective fluid conduits. The space 16 is filled with a working fluid and the feed inlet 40 is sealed shut.

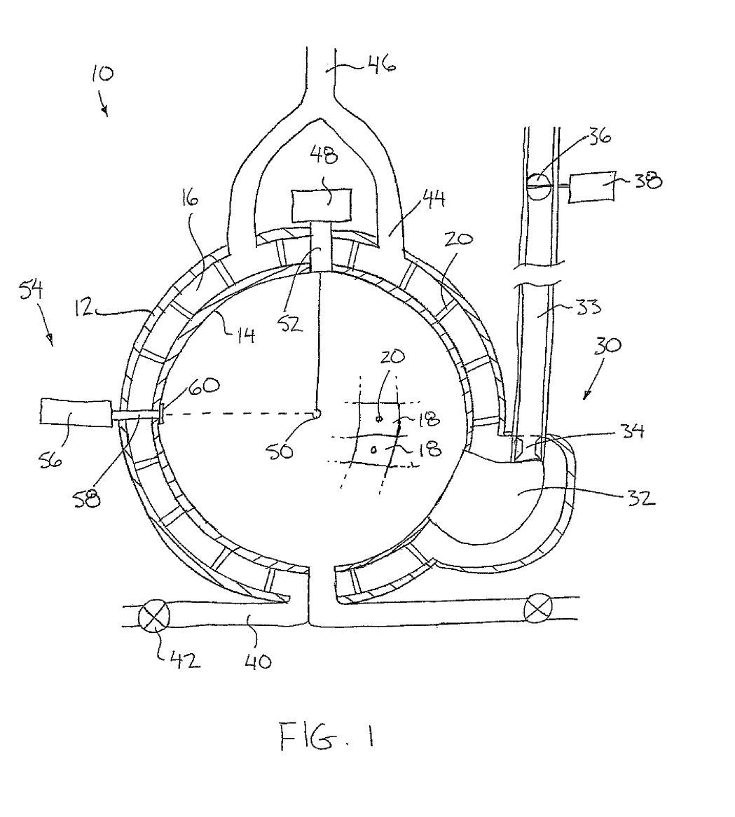

According to the embodiment of FIG. 1, the interior of the chamber 14 is prepared by first filling the chamber with water and then subsequently draining the water while partially filing the remaining volume with an inert gas so that once all of the water is drained from the inner chamber a partial vacuum of only inert gas is all that remains within the inner chamber 14. A target fuel pellet 50 is then suspended within the interior of the inner chamber at the center thereof and the feed tube is sealed shut prior to the driver mechanism being activated to initiate the reaction. Once the lasers 56 are activated, the driver tubes are immediately closed as the reaction begins. The build up of heat and pressure within the interior of the inner chamber 14 exerts pressure on the plugs 34 through the inlet chamber 32 to raise the fluid in the conduit 33 thereabove and thereby absorb some of the initial gas pressure build up of the reaction. Once the initial blast pressure is absorbed, the choke valves 36 are closed to contain as much heat and pressure within the inner chamber as possible. Subsequently opening the choke valves 36 again causes the fluid in the conduits 33 to urge the plugs 34 back down to the starting position to maintain pressure during the cooling phase of the interior of the inner chamber 14. Cooling of the interior of the inner chamber occurs by transferring heat to the water in the space 16 which produces steam to drive a turbine as noted above.

Typically, plural systems 10 would be operated and commonly feed their steam together to suitable turbine equipment. The reaction sequence of the systems would be arranged so that the resulting blasts or reactions would be evenly spaced at regular time intervals so as to produce as constant a pressure of steam as possible. Accordingly, the reaction within each system takes place while adjacent systems are at different stages of preparation for another reaction.

As described above, scientific research has demonstrated that certain types of lasers and particle beams are capable of producing the necessary temperatures to induce fusion from small capsules of isotopes of hydrogen, such as deuterium and tritium, when targeted by beams from a number of directions, typically as many as eight. The original beam might be mirrored to produce beams in these directions, and would probably require amplification by accelerators.

As further described herein, an energy reactor containment system generally comprises of a circular sphere consisting of an inner and outer shell with an appropriate space between them, and appropriately spaced structural plugs separating the shells. The inner shell is coated with an appropriate liner material 102, such as silicon carbide, and could consist of layered sheets. The outer shell might require to be reinforced with a layer of concrete, and would require an outer blanket of insulation to impede the escape of heat.

The inner shell is fastened to the outer shell and concrete with long bolts through appropriate channels to enable the inner shell to be removed and replaced. The whole sphere has channels for the driver beams.

The space between the two shells is filled with water to absorb the heat produced by the reaction and let off to a suitable chamber as steam, from which it is utilized to drive a steam turbine. A flow of water into the space is maintained until there is no longer sufficient heat to create steam. Since water is not compressible, the water would serve to strengthen the shell at the time of the initial reaction pressure build up.

The sphere has mechanisms to absorb and cushion the initial pressure in the form of appropriately sized water channels located just above openings in the bottom half of the sphere and leading upward to an appropriate water source such as a lake or river. The length of the channels makes it ideal for the sphere to be located underground. The channels would be plugged at the bottom, but with a plug capable of lifting the water channel when required to absorb the pressure produced by the reaction. The channels could be combined into one at an appropriate height. The pressure is confined at some point by choking off the upward flow and allowing the plugs to maintain pressure by sinking under the pressure of the water above back to its original position as pressure in the sphere reduces.

A further channel provides water to the space between the two shells from the bottom of the sphere, with a suitable valve to prevent back pressure from the steam, and with sufficient pressure to provide a flow of water to replace the water converted into steam.

The fuel capsule is presented by dropping it from the top of the sphere by an appropriate mechanism through a hole which could be immediately closed. The fuel feeding mechanism suspends the capsule in the middle of the sphere where the beams intercept one another to initiate the reaction on contact of the beams with the fuel. Mechanisms close the beam channels immediately after the beams were sent to the fuel capsule to prevent the escape of pressure through those channels. Circular rotating disks with one or more holes to uncover the channels serve this purpose. The disks would have a central axle, with a raised curved disk operating within a clasp to rotate when pushed to open, with spring loading to retract the disk when it is desired to close the channels.

It may be desirable to create a partial vacuum within the sphere prior to firing. This could be created by filling the inner sphere with water and then drawing it off from the bottom. To the extent that some gaseous material was desirable within the sphere during firing, this could be provided by an inert gas, preferably helium, which can be introduced during the draining process.

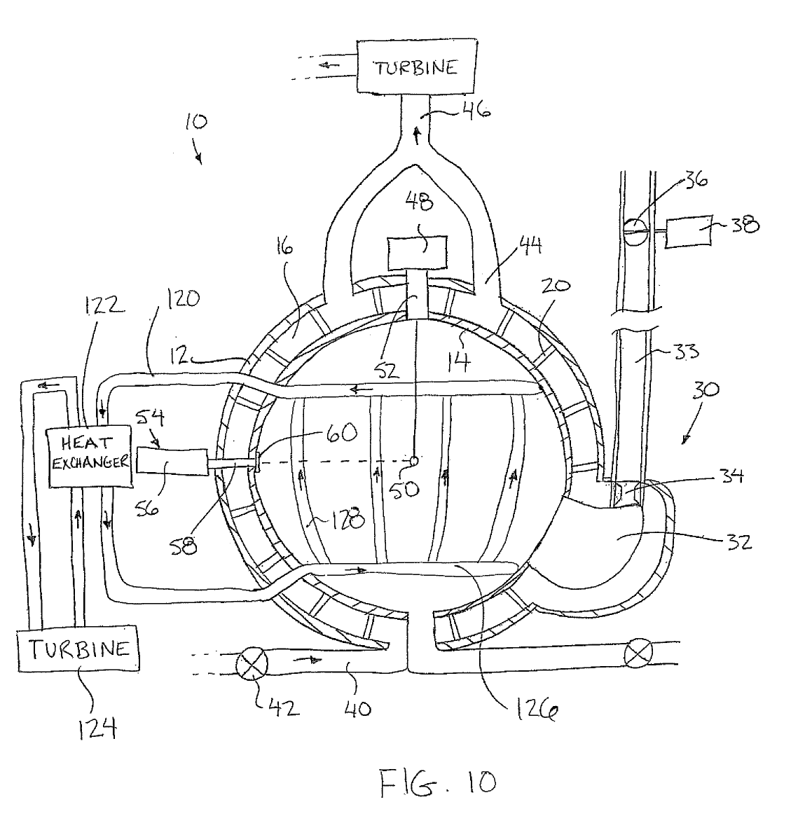

Turning now to a further embodiment illustrated in FIG. 9, the system 10 may be operated similarly to the embodiment of FIG. 1 with the exception of the interior of the inner containment chamber being partially filled with a metal 110 instead of arranging the inner containment chamber under vacuum pressure. The metal 110 is arranged to be in a flowable liquid form when a reaction takes place within the inner containment chamber. The inner walls of the inner containment chamber are accordingly arranged to be operated at temperatures and pressures which maintain the metal 110 in the flowable liquid form. A sufficient amount of metal is provided within the hollow interior of the inner containment chamber to nearly fill half of a volume of the inner containment chamber such that the inlet chambers 32 of the shock absorber system are arranged to be substantially fully submerged and filled with the liquid metal in the inner containment chamber. Accordingly when a reaction takes place within the inner containment chamber, the heat and pressure released from the reaction expands in the upper portion of the inner containment chamber to press downwardly on an upper surface of the metal 110 and cause the metal to flow into the inlet chambers 32 thus exerting pressure on the plugs 34 of the shock absorber system. The metal thus serves as a transfer medium for transferring flow and pressure of expanding gases in the inner containment chamber to the shock absorber system while also acting as a heat sink for extending the duration of heat transfer from the inner containment chamber to the fluid in the space between the inner and outer walls of the inner and outer containment chambers respectively. In a preferred embodiment the flowable liquid metal comprises lithium when the inner walls of the inner containment chamber are arranged to be operated at temperatures and pressures where lithium is present in a liquid form.

Turning now to FIG. 10, yet another embodiment of the system 10 is illustrated which again operates substantially identical to the embodiment of FIG. 1, with the exception of an additional heat exchanger 122 which is provided. The heat exchanger 122 communicates between heat exchanger tubing 120 and tubing containing a working fluid of an auxiliary turbine 124. The heat exchanger tubing 120 forms a plurality of passages for receiving heat exchanger fluid therethrough. The tubing is supported on the inner walls of the inner containment chamber for directly communicating with heat from a reaction which takes place within the inner containment chamber. More particularly the heat exchanger tubing includes a pair of generally annular shaped headers 126 extending in a generally circumferential direction adjacent top and bottom ends of the inner containment chamber as well as a plurality of upright tubes 128 communicating between the upper and lower headers. The heat exchanger fluid is circulated from the heat exchanger 122 through the tubing to enter into the inner containment chamber at one of the headers to be subsequently directed through the upright tubes 128 to the other headers where the fluid is then withdrawn from the inner containment chamber to be returned back to the heat exchanger 122. The heat exchanger fluid is selected to remain in a substantially liquid state as it is circulated through the inner containment chamber and the heat exchanger 122. The working fluid of the turbine 124 is circulated in a secondary loop between the turbine and the heat exchanger 122 for exchanging heat with the heat exchanger fluid at the heat exchanger 122. Once the working fluid is heated at the heat exchanger 122, the working fluid drives rotation of the turbine 124 to generate electricity according to a conventional turbine operation.

In other embodiments, the working fluid circulated through the heat exchanger 122 may comprise the working fluid of any other energy generating device which is arranged to produce useful forms of energy, for example electricity, from the heat extracted from the heat exchanger fluid. Also, the auxiliary turbine 124 may be provided in cooperation with the turbine communicating with the collector 46 or may be operable independently of the turbine driven by gas generated within the annular space 16 between the inner and outer walls of the inner and outer containment chambers respectively.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An energy reactor containment system comprising:
an outer wall defining an outer containment chamber therein;
an inner wall defining inner containment chamber supported within the outer containment chamber to define a space between outer wall of the outer containment chamber and the inner wall of the inner containment chamber;
a liquid filling the space between the walls of the inner and outer containment chambers;
a feed arranged to introduce the liquid into the space between the walls;
a target placer arranged to place a target fuel within the inner containment chamber;
a driver arranged to initiate an energy reaction which consumes the target fuel;
the liquid within the space between the walls of the inner and outer containment chambers being arranged to form a gas in the space between the walls of the inner containment chamber and the outer containment chamber responsive to the energy reaction; and
a collector arranged to collect the gas formed in the space directly from the space between the respective walls of the inner and outer containment chambers as the liquid in the space is heated by the energy reaction.

2. The device according to claim 1 wherein there is provided a shock absorption system coupled in communication with an interior of the inner containment chamber.

3. The device according to claim 2 wherein the shock absorption system comprises a moveable column of fluid which is arranged to be lifted when pressure within the inner containment chamber elevates.

4. The device according to claim 3 wherein there is provided a valve in communication with the column of fluid, the valve being operable between an open position and a closed position in which the valve prevents further movement of fluid within the column in the closed position such that further relief of pressure in the inner containment chamber is prevented when the valve is closed.

5. The device according to claim 3 wherein there is provided an inlet chamber defining a volume external from an interior volume defined by the inner chamber and in communication between the interior of the inner containment chamber and the column of fluid.

6. The device according to claim 1 wherein both the inner and outer containment chambers are spherical and wherein the chambers are concentric with one another.

7. The device according to claim 1 wherein an exterior of the outer containment chamber is insulated.

8. The device according to claim 1 wherein an interior surface of the inner containment chamber includes a liner of wear resistant material.

9. The device according to claim 1 wherein the inner containment chamber is formed of a plurality of plates abutted with one another in an overlapping configuration.

10. The device according to claim 9 wherein each plate is supported by a respective post spanning the space between the inner and outer containment chambers.

11. The device according to claim 1 wherein there is provided a plurality of channels spanning between the inner and outer chambers arranged to receive respective driver beams of the driver therethrough.

12. The device according to claim 11 wherein each channel includes a cover member which is rotatable between an open position arranged to communicate the driver beams therethrough and a closed position in which the channels are covered.

13. The device according to claim 1 wherein the target placer comprises a mechanism arranged to suspend the target fuel at a center of the inner containment chamber.

14. The device according to claim 1 wherein an interior of the inner containment chamber is partially filled with a metal and wherein the inner walls of the inner containment chamber are arranged to be operated at a temperature and pressure to maintain the metal in a flowable liquid form.

15. The device according to claim 1 in combination with a steam driven turbine arranged to generate electricity, the steam driven turbine being arranged to communicate with the collector so as to be arranged to generate electricity by the formation of the gas in the space between the inner and outer walls.

16. The device according to claim 1 wherein there is provided a plurality of heat exchanger passages supported on the inner walls of the inner containment chamber and arranged to communicate heat exchanger fluid between the inner containment chamber and an energy generating device arranged to produce useful energy from heat extracted from the heat exchanger fluid.

17. An energy reactor containment system comprising:
an outer wall defining an outer containment chamber therein;
an inner wall defining inner containment chamber supported within the outer containment chamber to define a space between outer wall of the outer containment chamber and the inner wall of the inner containment chamber;
a liquid filling the space between the walls of the inner and outer containment chambers;
a feed arranged to introduce the liquid into the space between the walls;
a target placer arranged to place a target fuel within the inner containment chamber;
a driver arranged to initiate an energy reaction which consumes the target fuel;
the liquid within the space between the walls of the inner and outer containment chambers being arranged to form a gas responsive to the energy reaction;
a collector arranged to collect the gas formed as the liquid in the space is heated by the energy reaction;
a shock absorption system coupled in communication with an interior of the inner containment chamber, the shock absorption system comprising:
a moveable column of fluid which is arranged to be lifted under force of elevating pressure within the inner containment chamber to relieve pressure in the inner containment chamber; and
a valve in communication with the column of fluid, the valve being operable between an open position and a closed position in which the valve prevents movement of fluid within the column in the closed position such that relief of pressure in the inner containment chamber is prevented when the valve is closed.

18. The device according to claim 17 wherein there is provided an inlet chamber defining a volume external from an interior volume defined by the inner chamber and in communication between the interior of the inner containment chamber and the column of fluid.

19. An energy reactor containment system comprising:
an outer wall defining an outer containment chamber therein;
an inner wall defining inner containment chamber supported within the outer containment chamber to define a space between outer wall of the outer containment chamber and the inner wall of the inner containment chamber;
a liquid filling the space between the walls of the inner and outer containment chambers;
a feed arranged to introduce the liquid into the space between the walls;
a target placer arranged to place a target fuel within the inner containment chamber;
a driver arranged to initiate an energy reaction which consumes the target fuel;
the liquid within the space between the walls of the inner and outer containment chambers being arranged to form a gas responsive to the energy reaction;
a collector arranged to collect the gas formed as the liquid in the space is heated by the energy reaction;
the walls of the inner containment chamber being formed of a plurality of plates abutted with one another in an overlapping configuration; and
each plate being respectively supported on the walls of the outer containment chamber by a respective post spanning the liquid filled space between walls of the inner and outer containment chambers.

20. The system according to claim 19 wherein each plate comprises flanges projecting outwardly from at least two sides, the flanges being overlapped by adjacent ones of the plates.
